(19) United States
(12) Patent Application Publication
(10) Pub. No.: US 2025/0334458 A1
(43) Pub. Date: Oct. 30, 2025

(54) SYSTEM FOR MEASURING THE POWER OF A MICROWAVE BEAM

(71) Applicants: Flavio LUCCA, MERATE (LC) (IT); HYPERTEC SOLUTION S.R.L., CESENA (FC) (IT); L.T. CALCOLI S.R.L, MERATE (LC) (IT)

(72) Inventor: Flavio LUCCA, MERATE (LC) (IT)

(21) Appl. No.: 18/870,925

(22) PCT Filed: May 30, 2023
(86) PCT No.: PCT/IB2023/055518

§ 371 Date: Dec. 2, 2024

(30) Foreign Application Priority Data
Jun. 1, 2022 (IT) 102022000011585

(51) Int. Cl. G01K 17/00; G01K 17/08

(52) U.S. Cl. CPC G01K 17/003; G01K 17/08

(57) ABSTRACT

Disclosed is a system for measuring the power of a microwave beam. The system includes a waveguide, a preload, a load, a diffusing mirror disposed inside the load, cooling conduits containing water lapping the against load, a thermometer for measuring the temperature of the water, and calculation means for calculating the power of the microwave beam based on a temperature increase of the water. Wherein the preload has a deviation box with a beam deviator configured in such a way to allow for a deviation and collimation of a microwave beam exiting the deviation box with respect to a microwave beam entering the deviation box.

The present invention relates to a system for measuring the power of a microwave beam.

Nuclear power plants are known to generate electricity using the nuclear fusion of a plasma consisting of charged particles (deuterium and tritium ions). The plasma is confined in a device, called Tokamak, by means of a magnetic field. Since the plasma is an electrical conductor, it can be heated by an externally induced current. However, such a heating is not sufficient to achieve the high temperatures required for the thermonuclear fusion. Therefore, it is necessary to provide an additional heating of the plasma, which can be accomplished by absorption into the plasma of electromagnetic waves (microwaves) injected through waveguides or antennas, which transfer electromagnetic energy to the plasma.

Thus, electromagnetic waves are used to heat (accelerate) the plasma. These electromagnetic waves are microwaves of defined frequency: e.g. 30-170 GHZ depending on the plasma component to be heated.

Bolometers are known to measure the power of the electromagnetic waves and thus understand if the boost given to the plasma by heating is as expected or if it is out of range. Basically, the bolometer is a sensor that allows for understanding whether the microwave beam is hitting the plasma with the expected energy in order to achieve the thermonuclear fusion. Hence, the measuring instruments used in plasma fusion nuclear power plants are extremely critical and important.

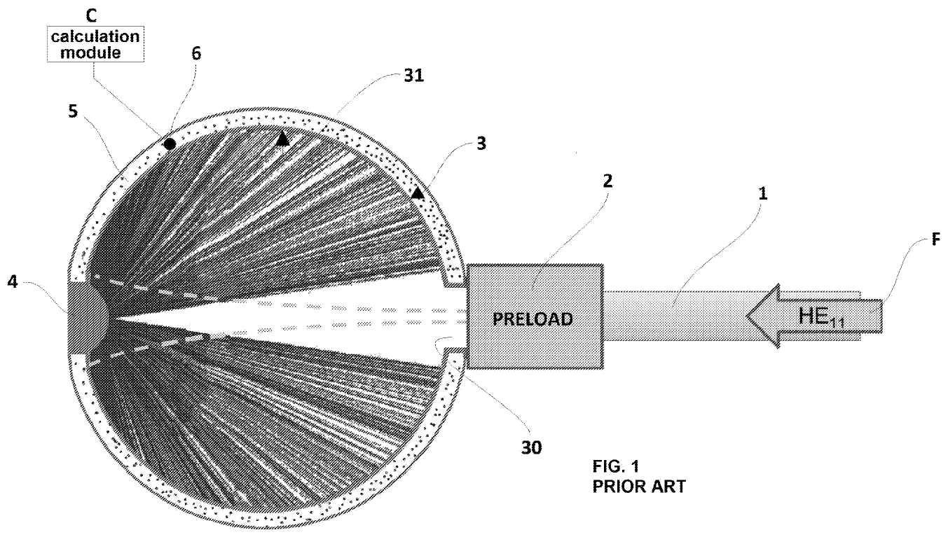

FIG. 1 illustrates a system for measuring the power of a microwave beam, according to the prior art, which is collectively indicated by the reference numeral 100.

The system (100) comprises: a waveguide (1), a preload (2) and a load (3). The waveguide (1) is coupled to the preload (2) and the preload (2) is coupled to the load (3)

A microwave beam (HE₁₁) (F) is introduced into the preload (2) via the waveguide (1), passes through the preload (2) and enters the load (3). By way of example, the microwave beam (F) can have propagation modes HE₁₁and can also have a percentage of impure modes.

The load (3) has an internally hollow spherical shape, having an inlet opening (30) and an inner surface coated with an absorbing coating (31) suitable for absorbing microwaves.

The load (3) comprises a diffusing mirror (4) of convex shape, arranged in a position diametrically opposite to the inlet opening (30) of the load. In this way, the microwave beam exiting the preload (2) enters the inlet opening (30) of the load, strikes the diffusing mirror (4) and is reflected on the absorbing coating (31). At each rebound of the electromagnetic wave, the absorbing coating (31), retains part of the power of the incident wave until it is cancelled.

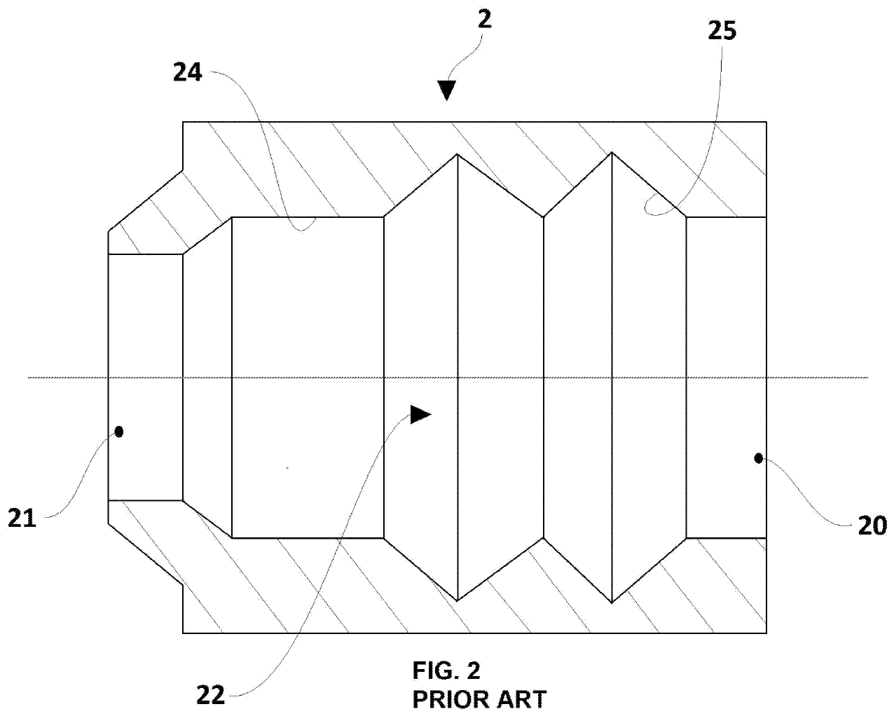

Referring to FIG. 2, the preload (2) is a hollow tube having an inlet (20) suitable for being coupled to the waveguide (1), an outlet (21) suitable for being coupled to the inlet opening (30) of the load and an axial duct (22). Since the outlet (21) is aligned with the inlet (20), the axial duct (22) has an accordion shape, with protuberances (24, 25) that ensure that the microwaves reflected by the diffusing mirror (4) do not return to the waveguide (1), i.e., do not exit the load (3), in such a way that all the power of the microwaves is captured by the load (3).

The load (3) is surrounded by cooling conduits (35) containing water (5) that laps against the load (3) acting as coolant. As a matter of fact, the electromagnetic power of the microwaves absorbed by the absorbing coating (31) heats the water (5) that laps against the load (3). A thermometer (6) is placed in the water (5) lapping against the load to measure the temperature of the water.

At the end of the emission of the microwave beam, the temperature increase of the water is measured. Such a temperature increase is proportional to the absorbed power, according to the following the formula:

$$P = {C}_{p} \cdot Δ T \cdot M$$

Where
Cp: specific heat of the water
ΔT: temperature variation of the water
M: total mass of the heated water.

Therefore, the thermometer (6) is connected to calculation means (C) configured to calculate the power of the microwave beam (F) based on a temperature increase of the water (5) measured by the thermometer (6).

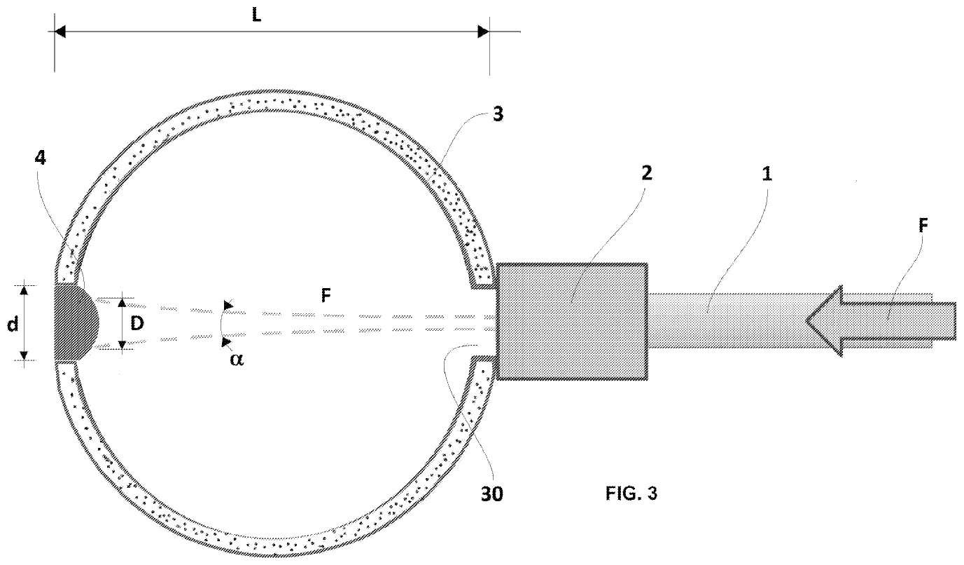

Referring to FIG. 3, the diffusing mirror (4) has a diameter (d) and the load (3) has an inner diameter (L).

For an effective distribution of the microwaves on the inner surface of the load (3) and to avoid areas of concentrated power on the inner surface of the load, it is important that the microwave beam (F) entering the inlet opening (30) of the load has an incidence front on the diffusing mirror (4) with a diameter (D) smaller than the diameter (d) of the diffusing mirror (4).

The microwave beam (F) entering the load (3) through the inlet opening (30) of the load tends to diverge with an opening angle (a) that depends on both the diameter (L) of the load and on the frequency of the microwave beam (F). Otherwise said, the opening angle (a) of the microwave beam is proportional to the diameter (L) of the load and inversely proportional to the frequency of the microwave beam (F).

The diameter (D) of the incidence front of the microwave beam (F) depends on the opening angle (a) of the beam and thus on the size of the load (6) and on the frequency of the microwave beam (F).

Generally, the microwave beams have a frequency greater than or equal to 170 GHz. Therefore, when a load (3) is designed, the diffusing mirror (4) is sized for microwave beams with a frequency greater than or equal to 170 GHz.

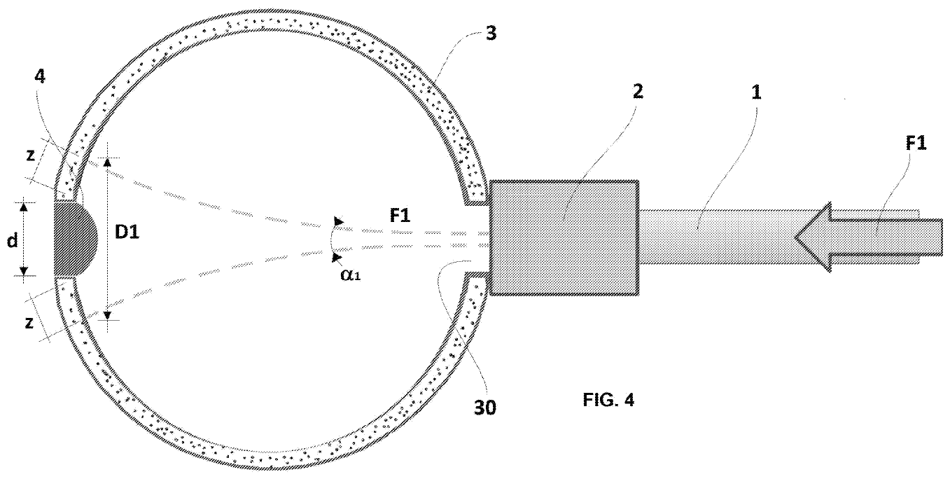

With reference to FIG. 4, if a microwave beam (F1) having a frequency lower than 170 GHz is used, such a microwave beam (F1) will have a larger opening angle (α1) than the microwave beam (F) shown in FIG. 3.

As a result, the microwave beam (F1) at a frequency below 170 GHz will have an incidence front on the diffusing mirror (4) having a diameter (D1) greater than the diameter (d) of the diffusing mirror.

Consequently, areas of concentrated power (Z) will be created on the inner surface of the load (3), just in a circular corona around the diffusing mirror (4), where the beam (F1) directly strikes, without being reflected by the diffusing mirror. Thus, in such a case, there is no effective distribution of the microwaves on the inner surface of the load (3).

JPH1168410A describes a power meter of a microwave beam having a cylindrical load.

BIN ET AL. “Advanced in high power calorimetric matched loads for short pulses and CW gyrotrons” describes a power meter of a microwave beam having a spherical load.

The purpose of the present invention is to eliminate the drawbacks of the prior art by providing a system for measuring the power of a microwave beam that is efficient, accurate, reliable and capable of avoiding a return of microwaves from the load towards the waveguide.

Another purpose of the present invention is to provide such a system for measuring the power of a microwave beam that is versatile and suitable for being used with microwave beams of different frequencies.

These purposes are achieved in accordance with the invention with the features of the appended independent claim 1.

Advantageous achievements of the invention appear from the dependent claims.

Further features of the invention will appear clearer from the following detailed description, which refers to a purely illustrative and therefore non-limiting embodiment thereof, illustrated in the appended drawings, wherein:

FIG. 1 is a diagrammatic view of a system for measuring the power of a microwave beam according to the prior art;

FIG. 2 is an axial sectional view of a preload of the system of FIG. 1;

FIG. 3 is a diagrammatic view of the system of FIG. 1, in the case of a microwave beam having a frequency greater than or equal to 170 GHz;

FIG. 4 is a diagrammatic view, like FIG. 3, in the case of a microwave beam having a frequency less than 170 GHz; and

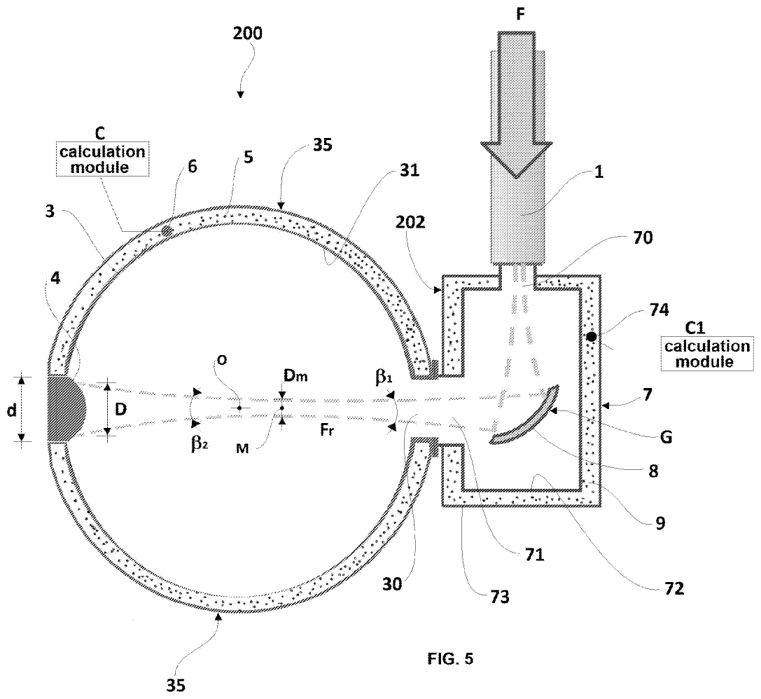

FIG. 5 is a diagrammatic view of a system for measuring the power of a microwave beam according to the invention.

Referring to FIG. 5, a system for measuring the power of a microwave beam according to the invention is described, which is collectively indicated by reference numeral 200.

Hereafter, elements equal or corresponding to those already described are indicated by the same reference numerals, and their detailed description is omitted.

The system (200) comprises a waveguide (1), a preload (202) and a load (3). The preload (202) of system (200) comprises a deviation box (7) instead of the hollow tube of the preload (2) of the system (100). The deviation box (7) comprises a beam deviator (G) that allows for a deviation of a microwave beam exiting the deviation box relative to a microwave beam entering the deviation box.

The deviation box (7) has an inlet (70) coupled to the waveguide (1) and an outlet (71) coupled to the inlet (30) of the load. The outlet (71) has an axis orthogonal to an axis of the inlet (70).

The beam deviator (G) can be any type of optical system that allows for a deviation of a microwave beam, such as a mirror system, a lens system, a diffraction prism system.

Advantageously, the beam deviator (G) comprises a concentrating mirror (8) arranged in the deviation box (7). In this way, the microwave beam (F) entering the deviation box (7) from the inlet (70) strikes the concentrating mirror (8) and is reflected, generating a reflected beam (Fr) that exits the outlet (71) of the deviation box and enters the load (3) through the inlet (30) of the load.

The concentrating mirror (8) generates a collimation of the reflected beam (Fr) that converges towards a point of convergence (M), wherein the reflected beam (Fr) has a minimum diameter (Dm). In this case, the reflected beam (Fr) has a convergence angle (β1).

Since the load (3) is spherical, the load (3) has a center (O). The point of convergence (M) of the beam is located inside the load (3), close to the center (O) of the load (3), for example, at a distance from the center (O) of the load (3) of less than one-tenth of the inner diameter of the load.

The reflected beam (Fr), which continues from the point of convergence (M) towards the diffusing mirror (4), is divergent with an opening angle (β2).

In this case, due to the presence of the concentrating mirror (8), the front of the reflected beam (Fr) striking the diffusing mirror (4) has a diameter (D) that is smaller than the diameter (d) of the diffusing mirror (4), even for microwave beams having a frequency below 170 GHz. The concentrating mirror (8) is designed to generate a collimation of the reflected beam (Fr) such that the diameter (D) of the front of the reflected beam (Fr) striking the diffusing mirror (4) is smaller than the diameter (d) of the diffusing mirror even for microwave beams having a frequency less than 170 GHz, for example, microwave beams having a frequency in the range from 10 GHz to 170 GHz.

The concentrating mirror (8) is concave. The concentrating mirror (8) preferably has a geometric shape of a paraboloid portion, in which the focus of the paraboloid coincides with the point of convergence (M) of the beam.

The deviation box (7) is internally coated with an absorbent coating (72) suitable for absorbing microwaves. The absorbent coating (72) of the deviation box (7) is preferably equal to the absorbent coating (31) of the load. In this way, the deviation box (7) can absorb that part of the microwave beam exiting the load (3) after being reflected by the diffusing mirror (4).

In addition, due to the fact that the microwave beam entering the deviation box from the waveguide (1) is not aligned with the microwave beam exiting the deviation box towards the load, the deviation box (7) is much more efficient than the preload (2) with hollow tub of the prior art in preventing the microwaves from returning into the waveguide (1).

In this case, since the absorbing coating (72) of the deviation box absorbs the microwaves and overheats, the deviation box (7) is externally cooled by cooling channels (73) with water (9) lapping against the deviation box. A second thermometer (74) is placed in the water (9) of the cooling channels (73) of the deviation box to detect the temperature of the water. In this way, by measuring the temperature increase of the water (9) of the cooling channels of the deviation box, the power of the microwaves exiting the load (3) can be measured exactly. The power of the microwaves exiting the load (3) constitutes a power drift value to be added to the power of the microwaves measured by the temperature increase of the water (5) lapping against the spherical load, so as to correct the detection of the total power of the microwave beam and obtain a much more accurate and reliable value.

Second calculation means (C1) are connected to the second thermometer (74) and are configured to calculate the power of the microwaves exiting the load (3), based on a temperature increase of the water (9) that cools the deviation box measured by said second thermometer (74).

Equivalent variations and modifications may be made to the present embodiment of the invention, within the scope of a person skilled in the art, which are nevertheless within the scope of the invention as expressed by the appended claims.

1. A system for measuring the power of a microwave beam comprising:
a waveguide for guiding a microwave beam whose power is to be measured,
a preload coupled to the waveguide,
a load coupled to the preload, wherein said load has an internally hollow spherical shape with an opening and an inner surface coated with an absorbing coating suitable for absorbing microwaves,
a diffusing mirror with convex shape, disposed inside the load in a diametrically opposite position with respect to the opening of the load to reflect the microwave beam on the absorbing coating of the load,
cooling conduits that contain water lapping against the load,
a thermometer disposed in the cooling conduits to measure the temperature of the water lapping against the load,
calculation means configured to calculate the power of the microwave beam based on a temperature increase of the water lapping against the load measured by said thermometer;
wherein said preload comprises a deviation box comprising a beam deviator suitably configured to permit a deviation of a microwave beam exiting the deviation box relative to a microwave beam entering the deviation box;
wherein said beam deviator of the deviation box comprises a concentrating mirror which is concave and is shaped like a portion of paraboloid; the concentrating mirror being suitable for reflecting the microwave beam whose power is to be measured, in such a way to obtain a reflected beam;
wherein the concentrating mirror generates a collimation of the reflected beam that is converged towards a point of convergence inside the load; the point of convergence coinciding with the focus of the paraboloid.

2. The system according to claim 1, wherein the deviation box has an inlet coupled to the waveguide and an outlet coupled to the opening of the load, and wherein the outlet has an inclined axis with respect to an axis of the inlet.

3. The system according to claim 1, wherein said concentrating mirror generates a collimation of the reflected beam that is converged towards said point of convergence inside said load, wherein the reflected beam has a minimum diameter in correspondence of said point of convergence that is smaller than a diameter of said diffusing mirror.

4. The system according to claim 1, wherein said load has a center and said point of convergence of the reflected beam is situated in the proximity of said center of the load.

5. The system according to claim 1, wherein said concentrating mirror is designed in such a way to generate a collimation of the reflected beam such that a diameter of a front of the reflected beam striking the diffusing mirror is smaller than a diameter of the diffusing mirror, for microwave beams with a frequency comprised in the range from 10 GHz to 170 GHz.

6. The system according to claim 1, wherein said deviation box is internally coated with an absorbing coating suitable for absorbing microwaves.

7. The system according to claim 6, comprising cooling channels with water that surround the deviation box and a second thermometer disposed in the water of the cooling channels of the deviation box to detect the temperature of the water used to cool the deviation box.

8. The system according to claim 7, comprising second calculation means configured to calculate the power of the microwaves exiting the load based on a temperature increase of the water used to cool the deviation box measured by said second thermometer.
